(19) United States
(12) Patent Application Publication
(10) Pub. No.: US 2024/0127258 A1
(43) Pub. Date: Apr. 18, 2024

(54) Warranty NFTs

(71) Applicant: STATE FARM MUTUAL AUTOMOBILE INSURANCE COMPANY, Bloomington, IL (US)

(72) Inventors: Joseph Robert Brannan, Bloomington, IL (US); Brian N. Harvey, Bloomington, IL (US); Edward W. Breitweiser, Bloomington, IL (US); Joseph P. Harr, Bloomington, IL (US)

(21) Appl. No.: 18/187,622

(22) Filed: Mar. 21, 2023

Related U.S. Application Data
(60) Provisional application No. 63/416,213, filed on Oct. 14, 2022.

(51) Int. Cl. G06Q 30/012; G06Q 20/36

(52) U.S. Cl. CPC G06Q 30/012; G06Q 20/36; G06Q 2220/16

(57) ABSTRACT

The following relates generally to creating a backup of data and/or settings of a smart device. In some embodiments, one or more processors receive the data and/or settings of the smart device. The one or more processors may then mint a non-fungible token (NFT) that references a link to a data storage area. The data storage area may store: (i) an identification of the smart device, and/or (ii) the received data and/or settings of the smart device. The following also relates generally to providing a warranty of an item. In some embodiments, one or more processors detect an indication of a sale. The one or more processors may then mint a warranty non-fungible token (NFT) that: (a) is owned by the owner of the item, (b) identifies the item, and (c) identifies warranty information of the item.

### CROSS REFERENCE TO RELATED APPLICATIONS

This application claims the benefit of U.S. Provisional Patent Application No. 63/416,213, entitled “NFTs as a Backup/Restore Option, and Warranty NFTs,” filed Oct. 14, 2022. U.S. Provisional Patent Application No. 63/416,213 is hereby expressly incorporated by reference herein in its entirety.

### FIELD

The present disclosure generally relates to using non-fungible token (NFT) technology to (i) create backup data of smart devices, and/or (ii) provide a warranty of an item.

### BACKGROUND

Many smart devices include user-configurable settings (e.g., a smart thermostat may have a schedules of temperatures set by a user, etc.) and/or record data (e.g., the smart thermostat records historical temperature data, etc.). However, in some instances, the settings and/or data may be lost (e.g., due to corruption of the data, physical destruction of the smart device, hacking and/or theft of the data, etc.).

In addition, in today's marketplace, many items are sold along with a warranty of the item. However, an owner of the item, such as a person who originally purchased the item, may not keep track of the warranty (e.g., the person may forget that the item has a warranty, forget the warranty's expiration date, etc.). Furthermore, if the owner of the item transfers ownership of the item (e.g., sells the item, trades the item, gifts the item, etc.) to a new owner, it may be difficult to track the transferability and/or changes in ownership of the warranty as item ownership changes. Conventional techniques may have additional drawbacks as well.

### SUMMARY

The present embodiments relate to, inter alia, creating a backup of data and/or settings of a smart device. For example, many smart devices include settings and/or record data. Yet, in some instances, the settings and/or data may be lost (e.g., due to corruption of the data, physical destruction of the smart device, hacking and/or theft of the data, etc.). The techniques described herein provide a solution to this

In one aspect, a computer-implemented method for creating a backup of data and/or settings of a smart device may be provided. The method may be implemented via one or more local or remote processors, transceivers, sensors, servers, memory units, smart devices, mobile devices, wearables, smart watches, smart glasses, augmented reality glasses, virtual reality headsets, and/or other electronic or electrical components which are in wired or wireless communication over one or more radio frequency links. For instance, the method may include: (1) receiving, via one or more processors, and from a reference smart device, an indication of the data and/or settings of the reference smart device; (2) minting, via the one or more processors, a non-fungible token (NFT), wherein the minted NFT references a location of a data storage area, wherein the data storage area stores: (i) an identification of the smart device, and/or (ii) the received data and/or settings of the smart device; (3) adding, via the one or more processors, the NFT to a digital wallet; (4) receiving, via the one or more processors, a request to restore a target smart device using the data and/or settings associated with the NFT; and/or (5) in response to receiving the request: retrieving, via the one or more processors, the data and/or settings from the data storage area referenced by the NFT; and/or sending, via the one or more processors, the data and/or settings to the target smart device. The method may include additional, fewer, or alternate actions, including those discussed elsewhere herein.

In another aspect, a computer system for creating a backup of data and/or settings of a smart device may be provided. The computer system may include one or more local or remote processors, transceivers, sensors, servers, memory units, smart devices, mobile devices, wearables, smart watches, smart glasses, augmented reality glasses, virtual reality headsets, and/or other electronic or electrical components which are in wired or wireless communication over one or more radio frequency links. In one instance, the computer system may include the smart device, and one or more processors configured to: (1) receive, from a reference smart device, an indication of the data and/or settings of the reference smart device; (2) mint a non-fungible token (NFT), wherein the minted NFT references a location of a data storage area, wherein the data storage area stores: (i) an identification of the smart device, and (ii) the received data and/or settings of the smart device; (3) add the NFT to a digital wallet; (4) receive a request to restore a target smart device using the data and/or settings associated with the NFT; and/or (5) in response to receiving the request: retrieve the data and/or settings from the data storage area referenced by the NFT; and/or send the data and/or settings to the target smart device. The computer system may include additional, less, or alternate functionality, including that discussed elsewhere herein.

In yet another aspect, a computer device configured to create a backup of data and/or settings of a smart device may be provided. The computer device may include: one or more processors and/or transceivers; and/or one or more memories coupled to the one or more processors. The one or more memories including computer executable instructions stored therein that, when executed by the one or more processors, may cause the one or more processors to: (1) receive, from a reference smart device, an indication of the data and/or settings of the reference smart device; (2) mint a non-fungible token (NFT), wherein the minted NFT references a location of a data storage area, wherein the data storage area stores: (i) an identification of the smart device, and (ii) the received data and/or settings of the smart device; (3) add the NFT to a digital wallet; (4) receive a request to restore a target smart device using the data and/or settings associated with the NFT; and/or (5) in response to receiving the request: retrieve the data and/or settings from the data storage area referenced by the NFT; and/or send the data and/or settings to the target smart device. The computer device may include additional, less, or alternate functionality, including that discussed elsewhere herein.

The present embodiments also relate to, inter alia, providing a warranty of an item. For example, to facilitate tracking the warranty, a system may be provided that mints a NFT that: is owned by the owner of the item, identifies the item, and/or identifies warranty information of the item (e.g., a party providing the warranty). The minting may occur at the point of sale (POS), or at any other point in time. Furthermore, when the item transfers ownership, the NFT ownership may transfer as well.

In one aspect, a computer-implemented method for providing a warranty of an item may be provided. The method may be implemented via one or more local or remote processors, transceivers, sensors, servers, memory units, smart devices, mobile devices, wearables, smart watches, smart glasses, augmented reality glasses, virtual reality headsets, and/or other electronic or electrical components which are in wired or wireless communication over one or more radio frequency links. For instance, the method may include: (1) detecting, via one or more processors, an indication of a sale of a warranty for the item, the indication of the sale including: (i) an indicator of an owner of the item, (ii) an identifier of the item, and/or (iii) an indicator of warranty information associated with a warranty for the item; (2) minting, via the one or more processors, a warranty NFT, wherein the warranty NFT: (a) is owned by the owner of the item, (b) identifies the item, and/or (c) identifies the warranty information of the item, wherein: (i) the warranty NFT identifies the item, and identifies the warranty information of the item by referencing a link to a data storage area, and (ii) the data storage area is configured to store the identifier of the item, and the indicator of the warranty information of the item; and/or (3) adding, via the one or more processors, the minted warranty NFT to a digital wallet associated with the owner of the item. The method may include additional, fewer, or alternate actions, including those discussed elsewhere herein.

In another aspect, a computer system for providing a warranty of an item may be provided. The computer system may include one or more local or remote processors, transceivers, sensors, servers, memory units, smart devices, mobile devices, wearables, smart watches, smart glasses, augmented reality glasses, virtual reality headsets, and/or other electronic or electrical components which are in wired or wireless communication over one or more radio frequency links. For instance, the computer system may include one or more processors configured to: (1) detect an indication of a sale of a warranty for the item, the indication of the sale including: (i) an indicator of an owner of the item, (ii) an identifier of the item, and (iii) an indicator of warranty information associated with a warranty for the item; (2) mint a warranty NFT, wherein the warranty NFT: (a) is owned by the owner of the item, (b) identifies the item, and/or (c) identifies the warranty information of the item, wherein: (i) the warranty NFT identifies the item, and/or identifies the warranty information of the item by referencing a link to a data storage area, and/or (ii) the data storage area is configured to store the identifier of the item, and the indicator of the warranty information of the item; and/or add the minted warranty NFT to a digital wallet associated with the owner of the item. The computer system may include additional, less, or alternate functionality, including that discussed elsewhere herein.

In yet another aspect, a computing device for providing a warranty of an item may be provided. The computing device may include one or more processors and/or transceivers, and/or one or more memories. The one or more memories having stored thereon computer-executable instructions that, when executed by the one or more processors, may cause the computing device to: (1) detect an indication of a sale of a warranty for the item, the indication of the sale including: (i) an indicator of an owner of the item, (ii) an identifier of the item, and (iii) an indicator of warranty information associated with a warranty for the item; (2) mint a warranty NFT, wherein the warranty NFT: (a) is owned by the owner of the item, (b) identifies the item, and/or (c) identifies the warranty information of the item, wherein: (i) the warranty NFT identifies the item, and/or identifies the warranty information of the item by referencing a link to a data storage area, and/or (ii) the data storage area is configured to store the identifier of the item, and the indicator of the warranty information of the item; and/or add the minted warranty NFT to a digital wallet associated with the owner of the item. The computing device may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts an exemplary computer system for creating a backup of data and/or setting of a smart device, according to one embodiment.

FIG. 2 illustrates exemplary nodes and an exemplary distributed ledger.

FIG. 3 illustrates exemplary nodes, and an exemplary transaction flow on a distributed ledger network.

FIG. 4 illustrates exemplary components of a node on a distributed ledger network.

FIG. 5 shows an exemplary computer-implemented method or implementation of creating a backup of data and/or settings of a smart device.

FIG. 6 shows an exemplary computer-implemented method or implementation of creating a backup of data and/or settings of a smart device, including updating the data and/or settings.

FIG. 7 shows an exemplary computer-implemented method or implementation of creating a backup of data and/or settings of a smart device, including detecting that a smart device is no longer functioning and/or that data and/or settings of the smart device have become corrupted.

FIG. 8 depicts an exemplary computer system providing a warranty of an item, according to an embodiment.

FIG. 9 shows an exemplary computer-implemented method or implementation of providing a warranty of an item, including transferring ownership of a warranty NFT.

FIG. 10 shows an exemplary computer-implemented method or implementation of providing a warranty of an item, including sending warranty information, and sending an offer to purchase an extended warranty.

### DETAILED DESCRIPTION

The systems and methods disclosed herein relate to, inter alia, (i) creating a backup of data and/or settings of a smart device; and/or (ii) providing a warranty of an item.

Generally, many smart devices include settings (e.g., a smart thermostat may have a schedule of temperatures set by a user), and/or record data (e.g., the smart thermostat records temperatures). However, in some instances, the settings and/or data may be lost (e.g., due to corruption of the data, physical destruction of the smart device, hacking and/or theft of the data, etc.).

To solve this problem and others, techniques described herein use a non-fungible token (NFT) to create a backup of data and/or settings of a smart device. Broadly speaking, an NFT is a record on a distributed ledger includes a unique token that identifies the record thereby making the record “non-fungible.” Typically, NFTs are associated with a digital asset (e.g., an image, an audio file, a digital ticket, and/or other types of digital assets). Techniques described herein relate to using NFTs that relate to digital assets that (i) backup smart device settings and/or data and/or (ii) maintain a digital record of a warranty associated with a physical object.

The NFT may include an indication a set of information describing the digital asset. As one example, the NFT may indicate a location (e.g., an HTTP address, an FTP address, an IP address, a IPFS address, and/or other types of addresses) at which the digital asset may be accessed. In some embodiments, the indicated location may be a direct address to the digital asset. In other embodiments, the indication location may be a directory at which multiple digital assets are located. For example, the indicated location for a backup NFT may include multiple backup files (e.g., multiple restore points, configurations associated with different users of the smart device, and so on).

As another example, the NFT may also include a set of rights and/or permissions associated with the data located at the indication location. For instance, the NFT may specify that the owner of the NFT has rights to use, copy, distribute, and/or display the digital asset. Techniques disclosed herein may relate to defining rights that relate to (i) the ability backup and/or restore device settings to the NFT, and/or (ii) the transferability (or other rights) associated with a warranty.

Additionally, the NFT may include an identifier associated with an owner of the NFT (e.g., an identifier of a digital wallet that holds the NFT, an identifier of the individual that owns the NFT, etc.) and/or a corresponding physical asset (e.g. a smart device and/or a physical asset covered by a warranty). Accordingly, when participant in the distributed ledger associated with the NFT submits a request to perform an interaction, a validation entity may compare the requested interaction and/or identifiers included in the request to the set of rights and/or the ownership information included in the NFT to ensure that the request is permitted under the terms of the NFT. If the validation entity validates that the request is permitted, the validation entity may perform the requested action. In some embodiments, the validation entity is a smart contract associated with the NFT and/or a node that is executing the code associated therewith.

Exemplary System for Creating a Backup of Data and/or Settings of a Smart Device

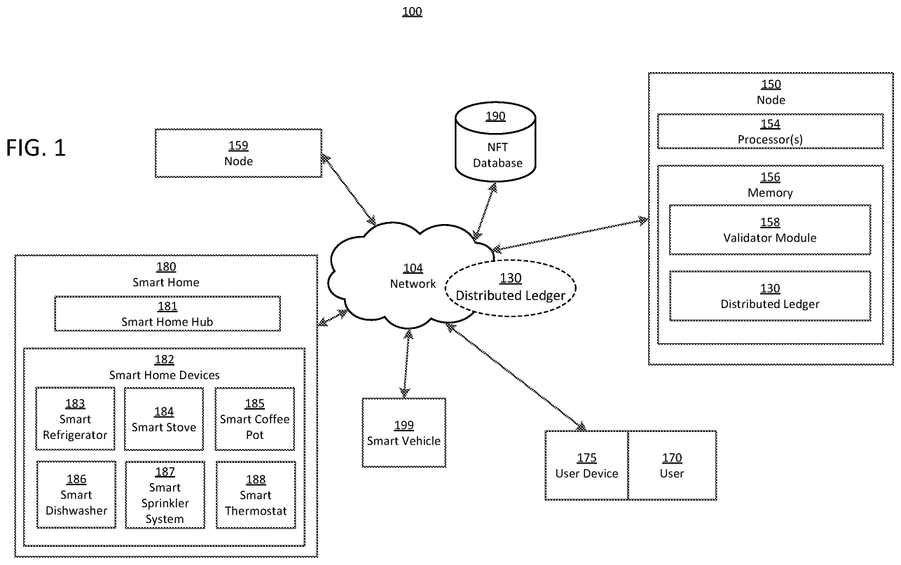

Generally, FIG. 1 shows an exemplary computer system 100 for creating a backup of data and/or settings of a smart device in which the exemplary computer-implemented methods described herein may be implemented. The high-level architecture includes both hardware and software applications, as well as various data communications channels for communicating data between the various hardware and software components.

By way of brief overview, the distributed ledger 130 may maintain records of NFTs, such as NFTs for storing backups of data and/or settings associated with smart devices. In some embodiments, the backups of the data and/or settings are stored in the NFTs themselves. In other embodiments, the backups of the data and/or settings are stored in a data storage area (e.g., such as to a storage area in NFT database 190), and NFTs references a link to the data storage area.

The distributed ledger 130 may be maintained by a plurality of nodes, such as nodes 150, 159. According to embodiments, the nodes 150, 159 may be a combination of hardware and software components. The nodes 150, 159 may each include a memory 156, one or more processors 154, such as a microcontroller or a microprocessor, and other components not shown in FIG. 1 (e.g., a random-access memory (RAM), and/or an input/output (I/O) circuit), all of which may be interconnected via an address/data bus.

The memory 156 and/or RAM may store various applications for execution by the one or more processors 154. For example, a user interface application may provide a user interface to the node 150, which user interface may, for example, allow the system administrator to configure, troubleshoot, and/or test various aspects of the node's operation.

The memory 156 may be tangible, non-transitory memory and may include any types of suitable memory modules, including RAM, read-only memory (ROM), flash memory, other types of persistent memory, etc. The memory 156 may store, for example, instructions executable on the processors 154 for a validator module 158.

The validator module 158 may validate changes to the blockchain (e.g., when a new transaction and/or block is created) and/or the execution of smart contracts maintained thereon according to a set of consensus rules. The consensus rules depend on the information being tracked by the blockchain and may include rules regarding the chain itself. For example, a consensus rule may include that the originator of a change supply a proof-of-identity such that only approved entities may originate changes to the chain. Consensus rules may include a mechanism to determine the order in which new blocks are added to the chain (e.g., through a proof-of-work system, proof-of-stake, etc.).

The validator module 158 may append distributed ledger data to the distributed ledger 130 if the distributed ledger data satisfies the consensus rules by generating a new block of validated transactions to include in the distributed ledger 130 and/or by broadcasting a block of transactions to other nodes. Otherwise, the validator module 158 may disregard any distributed ledger data that does not satisfy the consensus rules, and the distributed ledger data is not propagated to other nodes.

The distributed ledger 130 may be accessed by user 170 through the user device 175 (e.g., a virtual reality (VR) headset, a computer, a tablet, a smartphone, an augmented reality (AR) headset, a server, etc.). In some embodiments, the user device 175 is itself a node of the distributed ledger 130.

The NFT database 190, in some embodiments, may be a database that broadly stores any information of NFTs of the distributed ledger 130 (e.g., backups of data and/or settings of a smart device, etc.). While FIG. 1 illustrates the NFT database 190 as a single entity, in other embodiments, the NFT database 190 includes any number of storage entities configured to store information with any number of the NFTs associated with the distributed ledger 130.

The smart devices may be any kind of smart devices. Examples of the smart devices include smart home devices 182, such as smart kitchen appliances (e.g., smart refrigerator 183, smart stove 184, smart microwave, smart coffee pot 185, smart dishwasher 186, smart toaster, etc.), smart thermostat 188, smart washing machine, smart dryer, smart sump pump, smart toothbrush, smart sprinkler system 187, etc. However, the smart device does not necessarily need to be part of a smart home 180, and a further example of a smart device includes smart vehicle 199 (e.g., a smart car, truck, motorcycle, all-terrain vehicle (ATV), drone, plane, helicopter, etc.).

Advantageously, a smart home hub 181 may gather data from the smart home devices 182.

In addition, further regarding the example system 100, the illustrated example components may be configured to communicate, e.g., via a network 104 (which may be a wired or wireless network, such as the internet), with any other component. Furthermore, although the example system 100 illustrates only one of many of the components, any number of components are contemplated (e.g., any number of users, user devices, nodes, databases, distributed ledgers, smart devices, etc.).

Exemplary Distributed Ledgers for Creating a Backup of Data and/or Settings of a Smart Device and/or Providing a Warranty of an Item

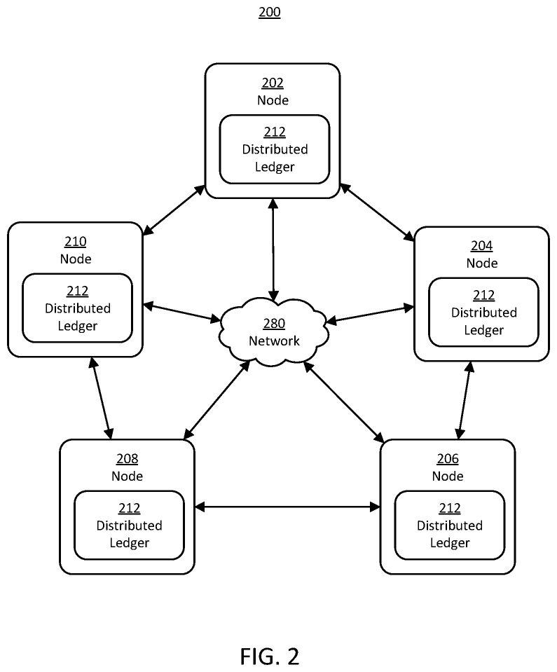

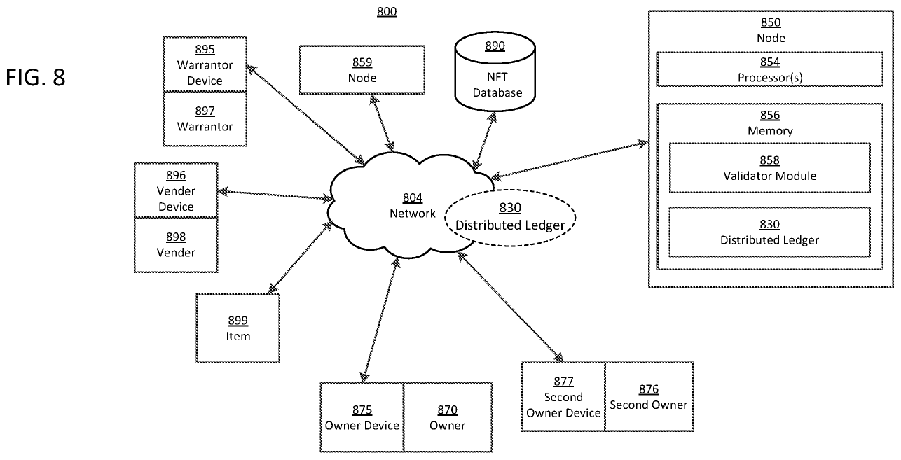

FIG. 2 depicts an exemplary distributed ledger system 200 for creating a backup of data and/or settings of a smart device and/or providing a warranty of an item. The system 200 may include a distributed ledger 212 (e.g., having one or more distributed ledger layers, such as the distributed ledger 130 of FIG. 1) and a plurality of nodes 202, 204, 206, 208, and 210 (e.g., each similar to node 150, 159 of FIG. 1, and/or node 850, 859 of FIG. 8, etc.). Each node maintains a copy of the distributed ledger 212. As changes are made to the distributed ledger 212, each node receives the change via the network 280 and updates its respective copy of the distributed ledger 212. A consensus mechanism may be used by the nodes 202-210 in the distributed ledger system 200 to decide whether it is appropriate to make received changes to the distributed ledger 212 or to a particular layer of the distributed ledger 212.

Each node in the system therefore has its own copy of the distributed ledger 212, which is identical to every other copy of the distributed ledger 212 stored by the other nodes. The distributed ledger system 200 may be more robust than a central authority database system because of the distributed ledger's decentralized nature. As such, there is no single point of failure on the distributed ledger system 200 as there would be in a centralized system.

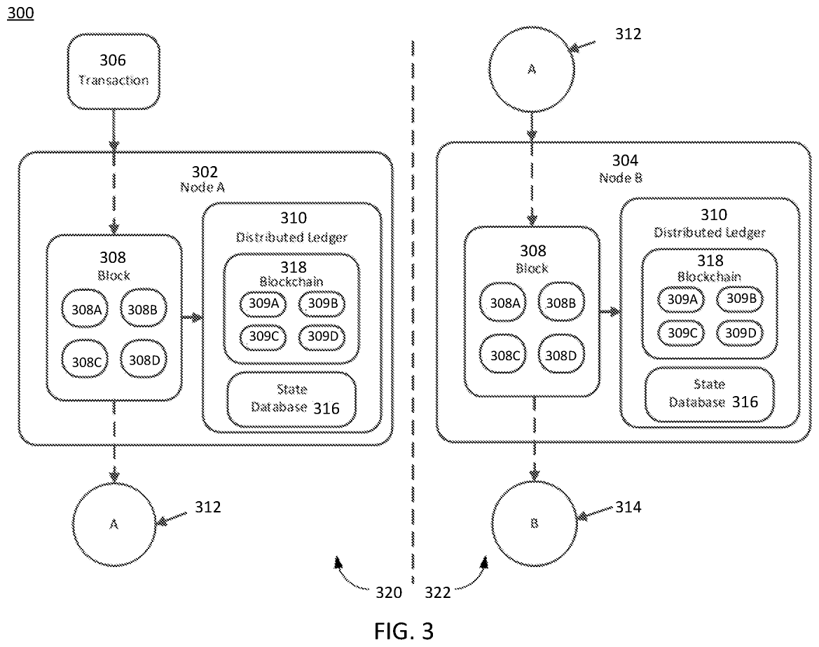

FIG. 3 depicts exemplary nodes and an exemplary transaction flow 300 on a distributed ledger network for creating a backup of data and/or settings of a smart device, and/or providing a warranty of an item. FIG. 3 includes two time frames 320 and 322 represented by the left and right sides of the dotted line, respectively, Node A 302 (e.g., node 150, node 850, etc.) and Node B 304 (e.g., node 159, 859, etc.), a set of transactions 308A-308D, a set of blocks of transactions 309A-309D, a distributed ledger 310, and a blockchain 318.

The block propagation flow 300 may begin with Node A 302 receiving transaction 306 at time 320. When Node A 302 confirms that transaction 306 is valid, Node A 302 may add the transaction to a newly generated block 308. As part of adding the transaction 306 to block 308, Node A 302 may solve a cryptographic puzzle and include the solution in the newly generated block 308 as proof of the work done to generate the block 308. Alternatively, a proof of stake algorithm may be used to generate the block 308, whereby Node A 302 “stakes” an amount of a digital token used on the network, however, the network itself determines the node that will mint the new block. In another implementation, a proof of authority (PoA) algorithm may be used to generate the block 308, where transactions and blocks are validated by approved accounts, known as validators which run software allowing them to record transactions in the distributed ledger.

In other embodiments, the transaction 306 may be added to a pool of transactions until a sufficient number of transactions in the pool exist to form a block or distributed ledger entry. Node A 302 may transmit the newly created distributed ledger entry 308 to the network at time 312. Before or after propagating the distributed ledger entry 308, Node A 302 may add the distributed ledger entry 308 to its copy of the blockchain 318.

While proof of work, proof of stake, and proof of authority are described herein as consensus algorithms for selecting a node to mint a new block, these are merely a few example consensus algorithms and are not intended to be limiting. Additional consensus algorithms may be utilized, such as delegated proof of stake where nodes elect a subset of nodes referred to as delegates to perform validation, and the delegates take turns minting new blocks. Consensus algorithms may also include proof of weight, Byzantine fault tolerance, tangle consensus algorithms, block lattice consensus algorithms, etc. Additionally, quorum slices may be selected where a quorum is a set of nodes that participate in the consensus protocol and a quorum slice is its subset that helps a node in its agreement process. Individual trust decisions may be made by participants in the distributed ledger network to construct a quorum slice. Still further, security circles may be identified which are closed groups of network participants who together can form a quorum to reach a consensus on a transaction and to make further trust decisions.

In any event, the transactions 309A-309D may include updates to a state database 316. The state database 316 may contain current values of variables created by smart contracts deployed on the blockchain 318. Validated distributed ledger entries, such as distributed ledger entry 308, may include transactions effecting state variables in state database 316. At time 322, Node B 304 may receive the newly created distributed ledger entry 308 via the network at 312. Node B 304 may verify that the distributed ledger entry 308 is valid by checking the solution to the cryptographic puzzle provided in the distributed ledger entry 308. If the solution is accurate, then Node B 304 may add the distributed ledger entry 308 to its blockchain 318 and make any updates to the state database 316 as rejected by the transactions in distributed ledger entry 308. Node B 304 may then transmit the distributed ledger entry 308 to the rest of the network at time 314.

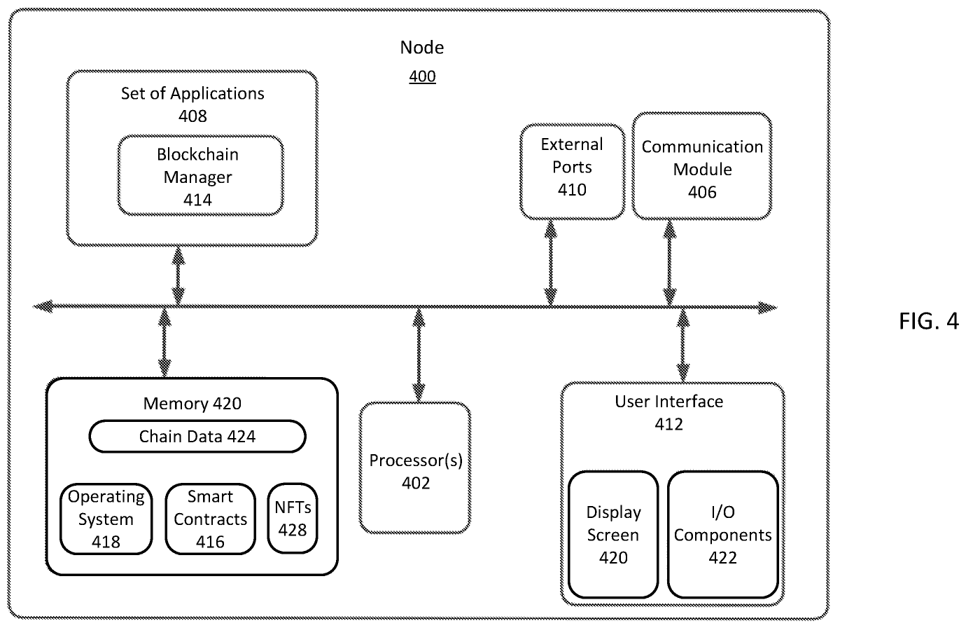

FIG. 4 depicts exemplary components of a node 400 on a distributed ledger network for creating a backup of data and/or settings of a smart device and/or providing a warranty of an item. The node 400 may be similar to the nodes 150, 159 described above with reference to FIG. 1, and/or nodes 850, 859 of FIG. 8. Node 400 may include at least one processor 402, memory 404, a communication module 406 such as a transceiver, a set of applications 408, external ports 410, a blockchain manager 414, smart contracts 416, NFTs 428, an operating system 418, user interface 412, display screen 420, and/or I/O components 422. In some embodiments, the node 400 may generate a new block of transactions, or may broadcast transactions to other nodes via the communication module 406 by using the blockchain manager 414. Similarly, the node 400 may use the blockchain manager 414 in conjunction with the NFTs 428 and/or the smart contracts 416 stored in the memory 404 to provide the functionality disclosed herein. The memory 404 may further include chain data 424 including, for example, a state database of the blockchain for storing states of smart contracts deployed thereon.

In other embodiments, the smart contracts 416 operate independent of the blockchain manager 414 or other applications. In some embodiments, the node 400 does not have a blockchain manager 414, NFTs 428, or smart contracts 416 stored at the node. In some embodiments, the node 400 may have additional or fewer components than described.

Exemplary Methods for Exemplary Creation of Backup of Data and/or Settings of a Smart Device

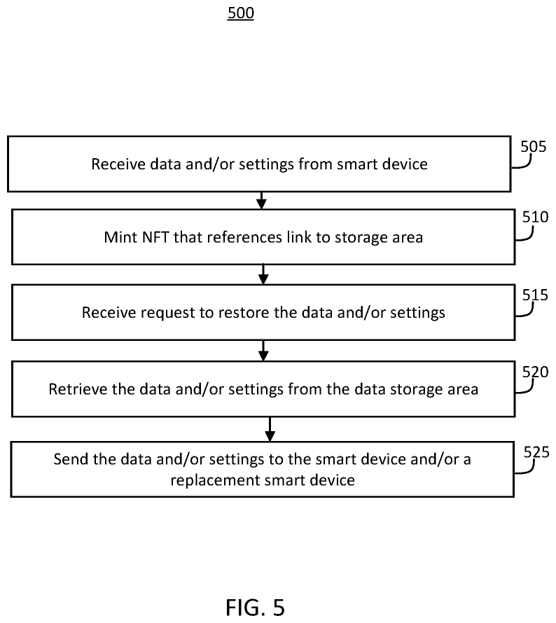

FIGS. 5-7 depict exemplary methods of creating a backup of data and/or settings of a smart device. The following discussion refers to the blocks as being performed by the one or more processors 154 of the node 150. However, any of the blocks may be performed by any processor(s) or combination of processors of any of the nodes, such as the nodes 150, 159. Additionally or alternatively, any of the blocks may be performed by smart contracts of the distributed ledger 130.

Starting with FIG. 5, FIG. 5 depicts an exemplary computer-implemented method 500 of creating a backup of data and/or settings of a smart device. The exemplary method 500 may begin at block 505 when the one or more processors 154 receive data and/or settings from a reference smart device.

In some examples, the reference smart device may be a smart thermostat 188. In some such examples, the data and/or settings may include any or all of a schedule of temperatures (e.g., a daily, hourly, weekly, etc. schedule), temperature data recorded by the smart thermostat 188, humidity data recorded by the smart thermostat 188, etc.

In some examples, the reference smart device may be a smart refrigerator 183. In some such examples, the data and/or settings may include a temperature setting of the refrigerator.

In some examples, the reference smart device may be a smart sprinkler system 187. In some such examples, the data and/or settings comprise a smart sprinkler system schedule (e.g., days of the week and/or times that the sprinkler system 187 will be activated, zones of the sprinkler system that will be activated, etc.).

In some examples, the reference smart device may be a smart coffee maker 185. In some such examples, the data and/or settings comprise a schedule (e.g., of times and/or times, etc.) that the smart coffee maker 185 will be activated to prepare coffee.

The one or more processors 154 may receive the data and/or settings from the reference smart device(s). Additionally or alternatively, one or more processors 154 may receive the data and/or settings from the smart home hub 181. In some such examples, the smart home hub aggregates data and/or settings from a plurality of smart home devices 182 before sending the aggregated data and/or settings to the one or more processors 154. This has the technical advantage of reducing the number of transmissions received by the one or more processors 154.

Furthermore, in some examples, the smart home hub 181 only sends data and/or settings for a particular kind of device (e.g., smart kitchen appliances). Additionally or alternatively, the smart home hub 181 may only send data and/or settings of smart devices that have a backup and restore option. This has the technical advantage of reducing the number of transmissions to the one or more processors 154 because data and/or settings from not all of the smart devices (e.g., in a smart home) is being transmitted.

In some embodiments, the reference smart device may be a smart vehicle 199. In some such examples, the data and/or settings include any data gathered by the smart vehicle 199, such as historical location data (e.g., a history of where and when the vehicle has traveled), gas mileage information of the vehicle, data gathered by devices of the vehicle (e.g., cameras, etc.), etc. Examples of settings may include preferred temperature settings, preferred seat position information, radio settings (e.g., favorite radio station information, etc.), etc.

The one or more processors 154 may store the data and/or settings of the reference smart device(s) in the NFT database 190. In some embodiments, the one or more processors 154 store an identification of the reference smart device(s) along with the data and/or settings. In some examples, the one or more processors 154 may store data and/or settings of related devices together. For example, the one or more processors 154 may store the data and/or settings of both a washer and dryer together in a data storage area of the NFT database 190. In some such examples, the one or more processors 154 may mint a single NFT (e.g., that references a link to the storage location storing the information for all of the related smart devices) for the related smart devices, thereby advantageously allowing the settings for both the washer and the dryer to be restored in tandem.

At block 510, the one or more processors 154 may mint an NFT. In some embodiments, the one or more processors 154 may also store the received data and/or settings in a storage area of the NFT database 190. In some such embodiments, the minted NFT may also references a link to the storage area. However, in other embodiments, the one or more processors 154 may store the data and/or settings in the minted NFT (rather than being stored in the NFT database 190). Regardless of where the data and/or settings are stored, the one or more processors 154 may store an identification of the reference smart device corresponding to the data and/or settings along with the data and/or settings.

In some embodiments, the one or more processors 154 may mint the NFT in response to receiving the data and/or settings of the reference smart device.

In some embodiments, the one or more processors 154 may mint an NFT to store (or enable storage of) the data and/or settings from more than one smart device. In this regard, as mentioned above, it may be technically advantageous to group transmissions of the data and/or settings of the smart devices by using the smart home hub 181 to aggregate the data and/or settings before transmission. The technical advantage may be further increased by then minting only a single NFT for all of the data and/or settings received in the single transmission (e.g., the nodes 150, 159 only need to mint one NFT, thus saving computational resources because, for example, the number of cryptographic puzzles that need to be solved is reduced). The single NFT may store the data and/or settings of any or all of the smart devices received in the transmission.

In some embodiments, the one or more processors 154 individually receives the data and/or settings from smart devices. The one or more processors 154 may then aggregate the data and/or settings until the data and/or settings from a predetermined number of smart devices is reached before minting the NFT. Again, the minted NFT may store the data and/or settings of any or all of the smart devices; and, additionally or alternatively, the NFT may reference a link to a location (e.g., a storage area of the NFT database 190) that stores the data and/or settings of any or all of the smart devices.

In some embodiments, the one or more processors 154 may store time stamps indicating when the data and/or settings were retrieved when storing the data and/or settings.

In some examples, the minted NFT includes a smart contract, which may include any suitable terms and/or data. In some examples, the smart contract may indicate a predetermined time period to request an update.

At block 515, the one or more processors 154 may receive a request to restore the data and/or settings to a target smart device. In some embodiments, the one or more processors 154 may receive the request from a smart device. In one example, a user 170 may accidently erase the data and/or settings from a smart device. Thus, the user may wish to restore the data and/or settings to the target smart device to backed up state, and accordingly command the target smart device to request restoration of the data and/or settings. In another example, the target smart device may detect that data and/or settings have become corrupted and automatically request restoration of the data and/or settings.

In another example, the one or more processors 154 may receive the request from the smart home hub 181. For example, the smart home hub 181 may determine that the data and/or settings of a smart device has become corrupted (and/or that the smart device has been physically destroyed and/or damaged), and request that the data and/or settings be restored to the target device.

In some embodiments, the request includes an indication of the target smart device to which the data and/or settings should be restored. In one example, a smart thermostat may be replaced (e.g., because the previous smart thermostat was destroyed or damaged, or simply replaced because the user 170 wanted a different smart thermostat). In this example, the request (regardless of where it is received from) may indicate that the data and/or settings backed up from the original, reference smart thermostat are to be restored to the replacement, target smart thermostat. In other examples, the target smart device is the same smart device as the reference smart device.

At block 520, the one or more processors 154 may retrieve the requested data and/or settings from the data storage area. Additionally or alternatively, one or more processors 154 may retrieve the data and/or settings from the NFT (e.g., in embodiments where the data and/or settings are partially or wholly stored in the NFT itself).

At block 525, the one or more processors 154 may send the data and/or settings to the target smart device. Additionally or alternatively, the one or more processors 154 may send the data and/or settings to the smart home hub 181, which then determines where to send the data and/or settings. Advantageously, sending the data and/or settings to the smart home hub improves data privacy (e.g., the request to the one or more processors 154 does not need to indicate if a replacement device has been purchased).

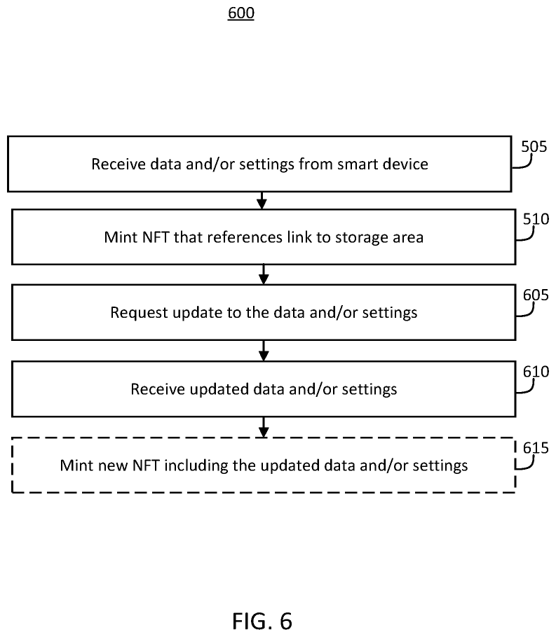

FIG. 6 shows an exemplary computer-implemented method or implementation 600 of creating a backup of data and/or settings of a smart device, including updating the data and/or settings.

The exemplary method or implementation 600 may begin with blocks 505 and 510 described with respect to the exemplary method or implementation 500.

At block 605, the one or more processors may request that the stored data and/or settings associated with the reference smart device are updated. In some embodiments, the one or more processors 154 may transmit the request at a predefined time interval specified for certain types of smart devices (e.g., updates requested every 6 months for smart thermostats, every 2 months for smart vehicles, etc.). Additionally or alternatively, the one or more processors 154 may transmit the request based upon a predefined time interval set in a smart contract that was minted along with the NFT at block 510 (e.g., a predefined time interval for a specific smart device, a group of smart devices, all smart devices of a certain type, etc.).

At block 610, the one or more processors 154 may receive the updated data and/or settings of the reference smart device (e.g., in response to the request sent at block 605). The one or more processors 154 may receive the updated data and/or settings in a similar manner as described with respect to block 520 of the exemplary method or implementation 500 (e.g., from a single smart device, from a group of smart devices, from the smart home hub 181, etc.). In some examples, the one or more processors 154 then overwrite the previous data and/or settings with the updated data and/or settings in the data storage area. However, in other examples, the one or more processors 154 create a second location within the data storage area, and store the updated data and/or settings in the second data storage area. Advantageously, this allows multiple versions of the backups to be created.

At block 615, the one or more processors 154 may optionally mint a new NFT. For instance, the new NFT may be minted as described with respect to block 510 of the exemplary method or implementation 500. For example, the newly minted NFT may reference a link to a new data storage area that stores: (i) an identification of the smart device(s), and (ii) the received new data and/or settings of the smart device(s). This new data storage area may be created in embodiments where the updated data and/or settings were not used to overwrite the data and/or settings, and/or embodiments where the updated data and/or settings were not stored in a second location within the data storage location.

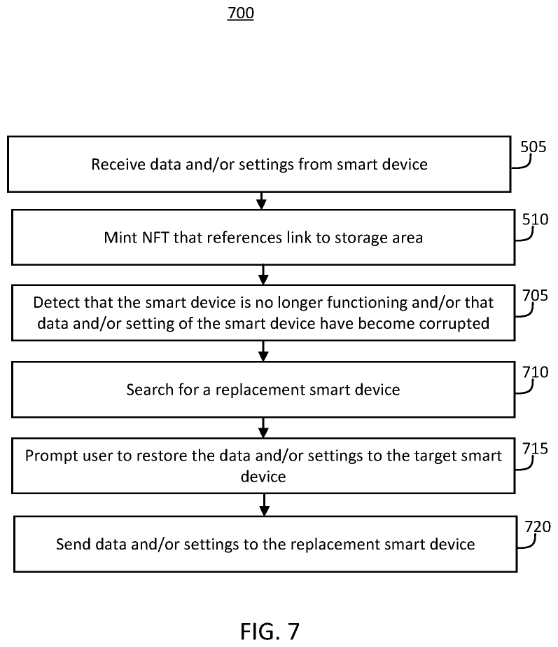

FIG. 7 shows an exemplary computer-implemented method or implementation 700 of creating a backup of data and/or settings of a smart device, including detecting that a smart device is no longer functioning and/or that data and/or settings of the smart device have become corrupted.

The exemplary method or implementation 700 may begin with blocks 505 and 510 described with respect to the exemplary method or implementation 500.

At block 705, the one or more processors 154 may detect that the reference smart device is no longer functioning and/or that data and/or settings of the reference smart device have become corrupted. In some examples, the one or more processors 154 detect these conditions by sending a request (e.g., for a status report, etc.) to the reference smart device, or to the smart home hub 181, etc. In these examples, the one or more processors 154 may determine, from the response to the request (or lack thereof), that the reference smart device is no longer functioning and/or that data and/or settings of the reference smart device have become corrupted. Furthermore, the one or more processors 154 may be configured to confirm that the reference smart device is actually not functioning property (as opposed to being simply powered off). Additionally or alternatively, the one or more processors 154 may verify that a setting of the reference smart device is not what is causing the malfunction. Advantageously, this prevents a scenario where a setting causing a malfunction spreads to multiple devices.

Additionally or alternatively, the smart home hub 181 may detect that the reference smart device is no longer functioning and/or that data and/or settings of the reference smart device have become corrupted. In response, the smart home hub 181 may report the loss of function to the one or more processors 154.

At block 710, the one or more processors 154 may search for a replacement target smart device. In some examples, to perform the search, the one or more processors 154 query the smart home hub 181 for new target smart devices and/or determine if any new target smart devices are capable of receiving the backed up data and/or settings. Additionally or alternatively, the one or more processors 154 may search for potential target smart devices on the same property as the reference smart device.

For example, the smart home hub 181 may periodically report a list of smart devices detected on the property. To this end, the list may identify the smart devices that transmitted a message (such as an event message, a polling message, etc.) over a communication network at the property within a threshold amount of time. Listed smart devices may include indications of a device identifier (such as a serial number, a MAC address, an IP address), a device type, a device manufacturer, a device model, a software version, and/or other data about the detected smart devices. Accordingly, the one or more processors 154 may search the list of smart devices to identify a smart device associated with the same device type, manufacturer and/or model as the reference smart device. By identifying target smart devices from the same manufacturer as the reference smart device, this may advantageously allow the data and/or settings to be restored to the target reference device in the same file format as maintained in the NFT.

In other embodiments, the one or more processors 154 may identify a potential target device that was manufactured by a different manufacturer as the reference smart device and/or is a different model from the smart device. In these embodiments, the fields associated with the backed up settings may not match those utilized in the target smart device. Accordingly, in these embodiments, the one or more processors 154 may apply a field mapping to re-format the data backed up to the NFT with a format implemented at target smart device.

At block 715, the user 170 may be prompted to restore the data and/or settings to the target smart device. Advantageously, this allows the user 170 to retain control of the smart device to which the data and/or settings are restored. This may eliminate the need for the user 170 to manually detect that the reference smart device lost functionality.

At block 720, upon receiving confirmation, the one or more processors 154 may send the data and/or settings to the target smart device (e.g., directly to the smart device, or through the in home hub 181).

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

Additional Exemplary Embodiments for Creating a Backup of Data and/or Settings of a Smart Device

In one aspect, a computer-implemented method for creating a backup of data and/or settings of a smart device may be provided. The method may be implemented via one or more local or remote processors, transceivers, sensors, servers, memory units, smart devices, smart vehicles, mobile devices, wearables, smart watches, smart glasses, augmented reality glasses, virtual reality headsets, and/or other electronic or electrical components which are in wired or wireless communication over one or more radio frequency links. For instance, the method may include: (1) receiving, via one or more processors, and from a reference smart device, an indication of the data and/or settings of the reference smart device; (2) minting, via the one or more processors, a non-fungible token (NFT), wherein the minted NFT references a location of a data storage area, wherein the data storage area stores: (i) an identification of the smart device, and/or (ii) the received data and/or settings of the smart device; (3) adding, via the one or more processors, the NFT to a digital wallet; (4) receiving, via the one or more processors, a request to restore a target smart device using the data and/or settings associated with the NFT; and/or (5) in response to receiving the request: retrieving, via the one or more processors, the data and/or settings from the data storage area referenced by the NFT; and/or sending, via the one or more processors, the data and/or settings to the target smart device. The method may include additional, fewer, or alternate actions, including those discussed elsewhere herein.

In some embodiments, the minting the NFT includes minting, via the one or more processors, the NFT in response to receiving the data and/or settings of the smart device.

In some embodiments: the smart device is a first smart device comprised in a group of smart devices including a second smart device; and the computer-implemented method further includes receiving, via one or more processors, and from the second smart device, data and/or settings of the second smart device; and/or the data storage area further stores: an identification of the smart second device, and the received data and/or settings of the second smart device.

In some embodiments, the first reference smart device comprises a smart washer, and the second reference smart device comprises a smart dryer. In some embodiments, the smart device comprises a kitchen appliance, a smart thermostat, or a smart vehicle. In some embodiments: (i) the smart device comprises a smart thermostat, and/or (ii) the data and/or settings include a schedule of temperatures.

In some embodiments: (i) the smart device comprises a refrigerator, and/or (ii) the data and/or settings include a temperature setting of the refrigerator. In some embodiments, the data storage area stores (iii) an indication of a time that the data and/or settings were received.

In some embodiments, minting the NFT includes minting the NFT with a smart contract, wherein the smart contract indicates a predetermined time period to request an update, and wherein the method further comprises requesting, via the one or more processors, an update to the data and/or settings based upon: (i) the indication of the time that the data and/or settings were received, and/or (ii) the predetermined time period.

In some embodiments, the method further includes: receiving, via the one or more processors, new data and/or settings of the reference smart device; and/or overwriting, via the one or more processors, the data and/or settings of the reference smart device with the new data and/or settings of the reference smart device in the data storage area.

In some embodiments, the data and/or settings are stored in a first location within the data storage area, and/or wherein the method further comprises: receiving, via the one or more processors, new data and/or settings of the reference smart device, wherein the data storage area stores the new data and/or settings of the reference smart device in a second location within the data storage area.

In some embodiments, the request is received from a replacement smart device, and/or wherein the sending the data and/or settings comprises sending the data and/or settings to the replacement smart device.

In some embodiments, the method further includes: detecting, via the one or more processors, that the reference smart device is no longer functioning while powered on; determining, via the one or more processors, that a cause of the smart device no longer functioning property is not a setting; in response to the determination, searching, via the one or more processors, for the target smart device, wherein the target smart device is: (i) of a same type as the reference smart device, and (ii) on a same property as the reference smart device; and/or upon finding the target smart device, prompt, via the one or more processors, a user to restore the data and/or settings to the target smart device.

In another aspect, a computer system for creating a backup of data and/or settings of a smart device may be provided. The computer system may include one or more local or remote processors, transceivers, sensors, servers, memory units, smart devices, mobile devices, wearables, smart watches, smart glasses, augmented reality glasses, virtual reality headsets, and/or other electronic or electrical components which are in wired or wireless communication over one or more radio frequency links. For instance, the computer system may include the smart device, and one or more processors configured to: (1) receive, from a reference smart device, an indication of the data and/or settings of the reference smart device; (2) mint a non-fungible token (NFT), wherein the minted NFT references a location of a data storage area, wherein the data storage area stores: (i) an identification of the smart device, and (ii) the received data and/or settings of the smart device; (3) add the NFT to a digital wallet; (4) receive a request to restore a target smart device using the data and/or settings associated with the NFT; and/or (5) in response to receiving the request: retrieve the data and/or settings from the data storage area referenced by the NFT; and/or send the data and/or settings to the target smart device. The computer system may include additional, less, or alternate functionality, including that discussed elsewhere herein.

In some embodiments, the smart device comprises a kitchen appliance, or a smart thermostat.

In some embodiments: (i) the smart device comprises a smart thermostat, and/or (ii) the data and/or settings include a schedule of temperatures.

In some embodiments: (i) the smart device comprises a refrigerator, and/or (ii) the data and/or settings include a temperature setting of the refrigerator.

In yet another aspect, a computer device configured to create a backup of data and/or settings of a smart device may be provided. The computer device may include: one or more processors and/or transceivers; and/or one or more memories coupled to the one or more processors. The one or more memories including computer executable instructions stored therein that, when executed by the one or more processors, may cause the one or more processors to: (1) receive, from a reference smart device, an indication of the data and/or settings of the reference smart device; (2) mint a non-fungible token (NFT), wherein the minted NFT references a location of a data storage area, wherein the data storage area stores: (i) an identification of the smart device, and (ii) the received data and/or settings of the smart device; (3) add the NFT to a digital wallet; (4) receive a request to restore a target smart device using the data and/or settings associated with the NFT; and/or (5) in response to receiving the request: retrieve the data and/or settings from the data storage area referenced by the NFT; and/or send the data and/or settings to the target smart device. The computer device may include additional, less, or alternate functionality, including that discussed elsewhere herein.

In some embodiments, the one or more memories having stored thereon computer executable instructions that, when executed by the one or more processors, cause the computer device to mint the NFT in response to receiving the data and/or settings of the smart device.

In some embodiments, the smart device comprises a kitchen appliance, or a smart thermostat.

### Exemplary System for Providing a Warranty of an Item

Broadly speaking, the following discloses techniques for using an NFT to track ownership of a warranty of an item. More specifically, some embodiments, mint a warranty NFT that: is owned by the owner of the item, identifies the item, and/or identifies the warranty information of the item. The minting may occur at the point of sale (POS), or at any other point in time. Furthermore, when the item transfers ownership, ownership of the NFT may transfer as well.

FIG. 8 shows an exemplary computer system 800 for providing a warranty in which the exemplary computer-implemented methods described herein may be implemented. The high-level architecture includes both hardware and software applications, as well as various data communications channels for communicating data between the various hardware and software components.

By way of brief overview, in some embodiments, a vender 898 may sell an item 899 to an owner 870. At the point of sale (POS), a warranty NFT may be minted that: (a) is owned by the owner 870 of the item 899, (b) identifies the item 899, and/or (c) identifies the warrantor 897. The warranty NFT may be used to track ownership of the warranty (e.g., if the ownership of the warranty transfers, the ownership of the warranty NFT may transfer as well, etc.), provide information of the warranty (e.g., terms of the warranty, expiration date of the warranty, etc.), initiate an extended warranty process, etc.

The warranty NFT may be recorded on the distributed ledger 830. In some embodiments, the information of the warranty (e.g., an identification of the item, an identification of the warrantor 897, terms of the warranty, expiration date of the warranty, etc.) may be stored in the NFTs themselves. In other embodiments, the information of the warranty may be stored in a data storage area (e.g., such as in a storage area in NFT database 890), and NFTs references a link to the data storage area.

The distributed ledger 830 may be maintained by a plurality of nodes, such as nodes 850, 859. According to embodiments, the nodes 850, 859 may be a combination of hardware and software components. The nodes 850, 859 may each include a memory 856, one or more processors 854, such as a microcontroller or a microprocessor, and other components not shown in FIG. 8 (e.g., a random-access memory (RAM), and/or an input/output (PO) circuit), all of which may be interconnected via an address/data bus.

The memory 856 and/or RAM may store various applications for execution by the node 850. For example, a user interface application may provide a user interface to the node 850, which user interface may, for example, allow the system administrator to configure, troubleshoot, and/or test various aspects of the node's operation.

The memory 856 may be tangible, non-transitory memory and may include any types of suitable memory modules, including RAM, read-only memory (ROM), flash memory, other types of persistent memory, etc. The memory 856 may store, for example, instructions executable on the processors 854 for a validator module 858.

The validator module 858 may validate changes to the blockchain (e.g., when a new transaction and/or block is created) and/or the execution of smart contracts maintained thereon according to a set of consensus rules. The consensus rules depend on the information being tracked by the blockchain and may include rules regarding the chain itself. For example, a consensus rule may include that the originator of a change supply a proof-of-identity such that only approved entities may originate changes to the chain. Consensus rules may include a mechanism to determine the order in which new blocks are added to the chain (e.g., through a proof-of-work system, proof-of-stake, etc.).

The validator module 858 may append distributed ledger data to the distributed ledger 830 if the distributed ledger data satisfies the consensus rules by generating a new block of validated transactions to include in the distributed ledger 830 and/or by broadcasting a block of transactions to other nodes. Otherwise, the validator module 858 may disregard any distributed ledger data that does not satisfy the consensus rules, and the distributed ledger data is not propagated to other nodes.

The distributed ledger 830 may be accessed by owner 870 through the owner device 875 (e.g., a virtual reality (VR) headset, a computer, a tablet, a smartphone, an augmented reality (AR) headset, a server, etc.). In some embodiments, the owner device 875 is itself a node of the distributed ledger 830.

Similarly, the distributed ledger 830 may be accessed by second owner 876 through the second owner device 877 (e.g., a virtual reality (VR) headset, a computer, a tablet, a smartphone, an augmented reality (AR) headset, a server, etc.). In some embodiments, the second owner device 877 is itself a node of the distributed ledger 830.

The NFT database 890, in some embodiments, may be a database that broadly stores any information of NFTs of the distributed ledger 830 (e.g., information of warranties, etc.). While FIG. 8 illustrates the NFT database 890 as a single entity, in other embodiments, the NFT database 890 includes any number of storage entities configured to store information with any number of the NFTs associated with the distributed ledger 830.

The warrantor 897 may be any suitable party that provides the warranty (e.g., warrants) the item 899. In some embodiments, the warrantor 897 may be a manufacturer (in whole or in part) of the item 899. Additionally or alternatively, the warrantor 897 may be the vender 898 (e.g., the party that sold the item 899). In some examples, any or all of the manufacturer, the vendor 898 and/or the warrantor 897 are the same party. The warrantor device 895 may be any suitable device used by the warrantor 897. For example, the warrantor device 895 may be a computing device, such as a server, a computer, a smart phone, a tablet, a phablet, etc.

The vender device 896 may be any suitable vender device. For example, the vender device 896 may be a point of sale (POS) device, a self-checkout device, a portable electronic device coupled to a barcode scanner and/or a QR code reader, etc.

In addition, further regarding the example system 800, the illustrated example components may be configured to communicate, e.g., via a network 804 (which may be a wired or wireless network, such as the internet), with any other component. Furthermore, although the example system 800 illustrates only one of many of the components, any number of components are contemplated (e.g., any number of owners, owner devices, nodes, databases, distributed ledgers, items, venders, warrantors, etc.).

### Exemplary Methods for Providing a Warranty of an Item

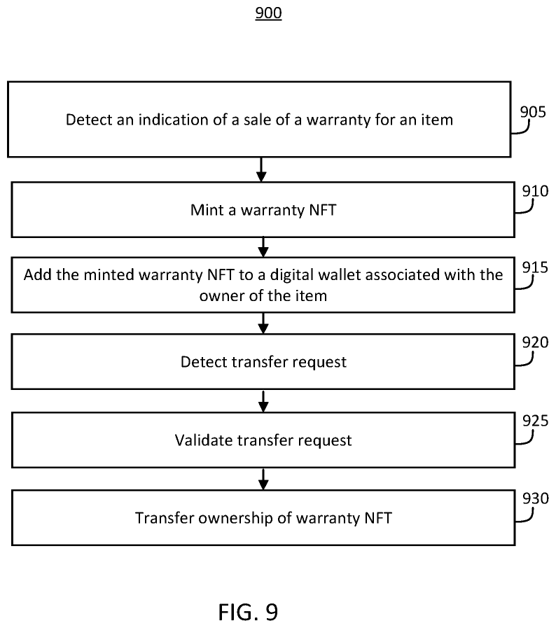

FIG. 9 shows an exemplary computer-implemented method or implementation 900 of providing a warranty of an item, including transferring ownership of the warranty NFT. The exemplary method or implementation 900 may be performed by the one or more processors 854 of the node 850.

The exemplary computer-implemented method or implementation 900 may begin at block 905 when the node 850 detects an indication of a sale of a warranty for an item. In some embodiments, this occurs at a point of sale (POS) of the item. In some embodiments, the indication of the sale includes: (i) an indicator of an owner of the item, (ii) an identifier of the item, and (iii) an indicator of warranty information associated with a warranty for the item.

In this regard, in some examples, when the owner 870 purchases the item 899 from the vender 898, the owner device 875 may display “would you like to purchase a warranty for this item?” If the owner 870 responds in the affirmative, any or all of the owner device 875, the vender device 896, and/or the warrantor device 895 may send any or all of (i)-(iii) to the node 850.

In some examples, the owner 870 may be prompted with a question asking if the owner 870 would like to mint a warranty NFT. For example, the item 899 may automatically come with a warranty, and, thus there is no need to ask if the owner 870 would like to purchase the warranty. In some such examples, the owner 870 may be prompted with a question, such as, “would you like to mint a warranty NFT for this item?” If the owner 870 responds in the affirmative, any or all of the owner device 875, the vender device 896, and/or the warrantor device 895 may send any or all of (i)-(iii) to the one or more processors 154.

The item 899 may be any kind of item for which a warranty may be purchased. Examples of types of the item 899 include electronics items, furniture items, kitchen appliances, yard appliances, vehicles, etc. Examples of electronics items include computers, tablets, phablets, smart phones, smart watches, etc. Examples of furniture items include chairs, tables, couches, desks, cabinets, etc. Examples of kitchen appliances include dishwashers, stoves, ovens, microwaves, refrigerators, freezers, kitchen fans, etc. Examples of yard appliances include lawn mowers, trimmers, leaf blowers, etc. Examples of vehicles include cars, trucks, drones, planes, helicopters, all-terrain vehicles (ATVs), etc. But these are only examples, and should not be seen as limiting the scope of the invention. Moreover, in some examples, the warranty may be a warranty for an individual part(s) of the item 899.

The indicator of the of the owner 870 of the item 899 may be any suitable indicator. For example, the indicator may include the owner's 870 name, address, phone number, username of a website, or any other identifying information, etc. In some examples the indicator includes a media access control address (MAC address), Internet Protocol address (IP address), a digital wallet identifier, etc.

The identifier of the item 899 may be any suitable identifier. In some examples, the identifier of the item 899 identifies the type of the item (e.g., identifies a particular model of computers). Additionally or alternatively, the identifier may identify a specific item (e.g., Jane Doe's computer). In some examples the identifier of the item may include serial number information, model number information, bar code information, quick response (QR) code information, etc. In some embodiments, the identifier information is captured by the vender device 896, which, in some embodiments, is a POS device.

The indicator of the warrantor 897 may be any suitable indicator. For example, the indicator may include the warrantor's 897 name (e.g., company name), address, phone number, username of a website, or any other identifying information, etc. In some examples the indicator includes a media access control address (MAC address), Internet Protocol address (IP address), etc.

At block 910, the node 850 mints a warranty NFT. In some embodiments, the warranty NFT: (a) is owned by the owner 870 of the item 899, (b) identifies the item 899, (c) identifies the warrantor 897 of the item 899, and/or (d) identifies terms of the warranty. In some embodiments, ownership of the NFT is recorded on the distributed ledger 830.

In some examples, the warranty NFT identifies the item, identifies the warranty information of the item, and/or identifies the terms of the warranty by referencing link(s) to a data storage area(s), such as a data storage area in the NFT database 890. Such embodiments provide technical advantages. First, in some embodiments, the terms of a warranty are stored in only one storage location. Thus, multiple warranty NFTs may reference links that all point to this storage location for the terms of the warranty. This thus has the technical advantage of saving storage space (e.g., over embodiments that store the terms of the warranty in the NFT itself, or store a separate copy of the warranty terms for each NFT, etc.). Another technical advantage is that if the terms of the warranty are to be updated (e.g., the warrantor 897 has decided to extend the warranty by a number of months, etc.), the terms only need to be updated in one storage location, thus saving computational resources at the NFT database 890.

Additionally or alternatively, the warranty NFT identifies the item, identifies the warranty information of the item, and/or identifies the terms of the warranty by storing information at the warranty NFT itself. As mentioned above, this has the drawback, in some embodiments, of requiring more storage space (e.g., the warranty terms must be stored in each NFT). Yet, some such embodiments bring a technical advantage as well. In particular, storing the information at the NFT makes the information immutable. Advantageously, this makes it difficult for or prevents the warrantor 897 from unilaterally altering the warranty terms in its favor. In another example, it improves data security because the NFT may be more difficult to hack than the NFT database 890.

The warranty NFT may identify the item 899 by any suitable technique. For example, the warranty NFT may (e.g., either by referencing a link to a data storage area, or by storing at the NFT itself) use serial number information, bar code information, and/or quick response (QR) code information to identify the item 899.

The warranty NFT may identify the warrantor 897 by any suitable technique. For example, the warranty NFT may (e.g., either by referencing a link to a data storage area, or by storing at the NFT itself) use the warrantor's 897 name (e.g., a company name), address, phone number, username of a website, or any other identifying information, etc. to identify the warrantor 897.

The warranty NFT may identify the terms of the warranty by any suitable technique. For example, the warranty NFT may either reference a link to a data storage area that stores the terms, or store the terms at the warranty NFT itself. In some embodiments, the warranty terms include conditions that the item 899 will or will not be replaced under, warranty terms for how the item will be replaced, an expiration date of the warranty, etc. In some embodiments, the terms of the warranty may be codified in the NFT smart contract. Accordingly, in these embodiments, the NFT smart contract may self-execute to enforce the purchased warranty.

In some examples, the node 850 may mint the NFT in response to receiving: (i) the indicator of the owner of the item, (ii) the identifier of the item, and/or (iii) the indicator of the warranty information of the item. For example, receiving (i)-(iii) (or any combination thereof) may trigger the node 850 and/or a smart contract to mint the warranty NFT. In some such examples, the owner device 875 and/or vender device 896 may automatically send (i) the indicator of the owner of the item, (ii) the identifier of the item, and/or (iii) the indicator of the warranty information of the item to the node 850 and/or smart contract at the POS. In these examples, the owner device 875 and/or vender device 896 may automatically send (i)-(iii) (or any combination thereof) upon sale of the item 899 to the owner 870. In some examples (e.g., where the owner 870 pays cash, etc.), the owner device 875 and/or the vender device 896 may capture an image of a QR code, a serial number, a barcode, etc. from the item 899 to detect (i)-(iii) (or any combination thereof).

Additionally or alternatively, the node 850 may mint the warranty NFT in response to receiving an acceptance of an offer to purchase a warranty for the item 899. For example, the owner 870 may use the owner device 875 to scan a barcode or QR code, which sends the decoded information of the item to the node 850. In response to receiving the information, the node 850 may send an offer to purchase a warranty for the item 899. The node 850 may then mint the warranty NFT upon acceptance of the offer.

At block 915, the node 850 may add the minted warranty NFT to a digital wallet associated with the owner 870 of the item. In some embodiments, the node 850 may write a transaction on the distributed ledger 830 that indicates the warranty NFT is to be added to the digital wallet associated with the owner 870. For example, the transaction may include the digital wallet identifier extracted from the received indicator of the owner of the item. In some embodiments, the node 850 obtains the digital wallet identifier by querying a digital wallet database using another type of indicator of the owner of the item.

At block 920, the node 850 may detect a transfer request indicating that ownership of the item 899 is to be transferred to a new owner (e.g., the second owner 876, etc.). The transfer request may be received from any suitable source, or combination of sources. For example, the transfer request may be received from any of the second owner device 877, the first owner device 875, the vender device 896, the warrantor device 895, and/or via a transaction on the distributed ledger 830.

In some examples, the node 850 may receive the transfer request from, for example, any of the second owner device 877, the first owner device 875, the vender device 896, and/or the warrantor device 895. In some examples, the owner device 875 and/or second owner device 877 decodes a QR code and/or barcode of the item 899 (such as a barcode code on the item 899 and/or presented on a display of the other of the owner device 875 and the second owner device 877), which triggers the owner device 875 and/or second owner device 877 to send an indication to the node 850 that ownership has been transferred. In other examples, upon scanning of the QR code and/or barcode, the owner device 875 and/or second owner device 877 may prompt the owner 870 and/or second owner 876 to confirm that ownership of the item 899 is to be transferred (e.g., by displaying a prompt that states “please confirm that ownership of this item has changed”). Upon the owner 870 and/or second owner 876 responding in the affirmative, the owner device 875 and/or second owner device 877 may send the indication(s) to the node 850.

At block 925, the node 850 may validate the transfer request. For example, the node 850 may validate the transfer request based upon a digital signature of: (i) a requester of the transfer, and/or (ii) the new owner 876.

At block 930, the node 850 may transfer ownership of the warranty NFT. For example, a transaction may be recorded on the distributed ledger 830 that transfers ownership of the warranty NFT from a digital wallet associated with the owner 870 to a digital wallet associated with the second owner.

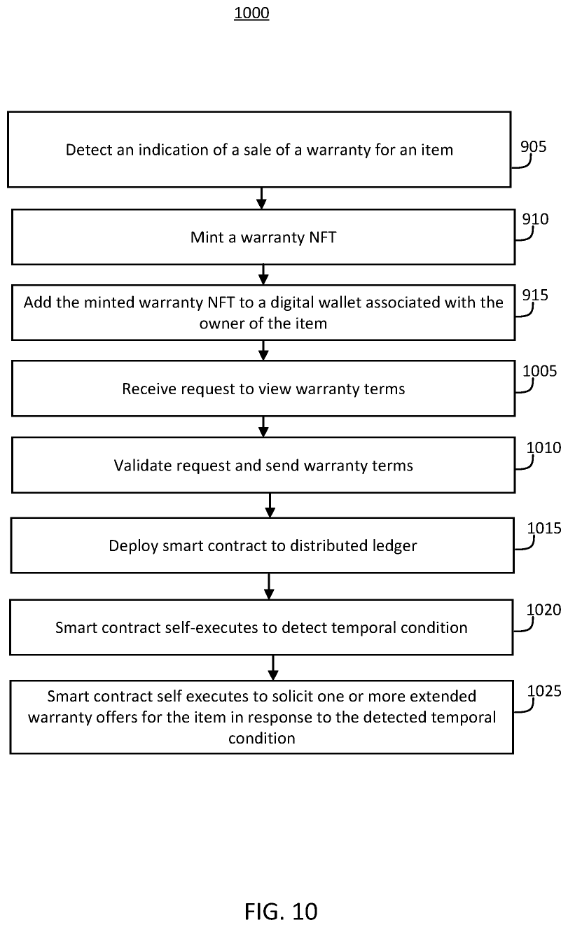

FIG. 10 shows an exemplary computer-implemented method or implementation 1000 of providing a warranty of an item, including sending warranty information (e.g., to a third party), and sending an offer to purchase an extended warranty. The exemplary method or implementation 1000 may be performed by the one or more processors 854 of the node 850.

The exemplary method or implementation 1000 may begin with blocks 905, 910, and 915, as described with respect to the exemplary method or implementation 900.

At block 1005, the node 850 may receive a request to view warranty information, such as the warranty terms and/or expiration date of the warranty. In some embodiments, the request is received via a transaction written to the distributed ledger 830. In some examples, the request is received from the owner 870. Additionally or alternatively, the request may be received from a third party, such as a third party that is considering offering an extended warranty to the owner 870.

At block 1010, the node 850 may validate the request and send the warranty terms information the requestor, or to a party indicated in the request. In some embodiments, the node 850 may validate that the requestor and/or the indicated party has sufficient permissions to view the warranty information. For example, the owner 870 may write a set of access rights to the warranty NFT smart contract. Accordingly, the warranty NFT smart contract may automatically enforce the access rights in response to detecting the request for the warranty information (e.g., by validating that an access right was provided along with the request, etc.).

In some examples, the different types of warranty information may be associated with the different access rights. For example, the expiration date of the warranty may have a first set of access rights that enable designated third parties to access the expiration date to provide an extended warranty offer. As another example, the amount of coverage may have a second set of access rights that restricts access to just the owner 870 and/or the warrantor 897.

At block 1015, the node 850 may deploy a smart contract to the distributed ledger 830. The smart contract may be configured to detect a temporal condition related to an expiration of the warranty. For example, the smart contract may detect that the warranty will expire within a predetermined time period (e.g., the warranty will expire within one week, two weeks, a month, etc.). Additionally or alternatively, the smart contract may be configured to solicit one or more extended warranty offers for the item upon detection of the temporal condition. In some embodiments, the node 850 may “deploy” the smart contract by modifying the warranty NFT smart contract to additionally detect the temporal condition related to the expiration of the warranty. In other embodiments, the node 850 may deploy a new smart contract for automating the warranty solicitation process.

At block 1020, the smart contract self-executes on the node 850 to detect the temporal condition related to the expiration of the warranty. For example, the distributed ledger 830 may include a global clock data feed to synchronize the transaction flow associated with the distributed ledger. Accordingly, the temporal condition of the smart contract may be configured to utilize the global clock data feed as the input parameter to detect the temporal condition.

At block 1025, the smart contract self-executes on the node 850 to solicit one or more extended warranty offers for the item in response to the detected temporal condition. For example, the node 850 executing the smart contract may send a solicitation request to a solicited party (e.g., the warrantor 897, a third party that offers extended warranties, etc.). In some such examples, the node 850 executing the smart contract may generate an access credential for use by the solicited party (e.g., for the solicited party to use when requesting warranty information), and/or generate an extended warranty solicitation request that is (i) addressed to the solicited party and/or (ii) includes the access credential. The node 850 executing the smart contract may then send the generated extended warranty solicitation request to the solicited party. In some further examples, the node 850 executing the smart contract encrypts the access credential using a public encryption key associated with the solicited party.

As a result, the solicited party may generate and send an offer for purchase of an extended warranty (e.g., to the owner of the item 899). Accordingly, the solicited party may generate a data request transaction to obtain the underlying data regarding the item 899 needed to generate the extended warranty terms. In some embodiments, the transaction may include a copy of the access credential that is encrypted using the private encryption key of the solicited party.

When the nodes executing the warranty NFT smart contract (which may include the node 850) detect the data request transaction, the nodes may validate the request. For example, the nodes may apply the public encryption key associated with the solicited party and confirm that the string resolves to the access credential. Upon validation of the data request, the nodes may enable the solicited party to obtain access to information relating to the warranty of the item 899 to generate the extended warranty offer. The solicited party may then generate and provide the extended warranty to the user 870 by any means known in the art. By only permitting solicited and authenticated parties access to generate extended warranty offers, the owner of the item may prevent the reception of unauthorized and/or undesired extended warranty offers.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Additional Exemplary Embodiments of Providing a Warranty of an Item

In one aspect, a computer-implemented method for providing a warranty of an item may be provided. The method may be implemented via one or more local or remote processors, transceivers, sensors, servers, memory units, smart devices, smart vehicles, mobile devices, wearables, smart watches, smart glasses, augmented reality glasses, virtual reality headsets, and/or other electronic or electrical components which are in wired or wireless communication over one or more radio frequency links. For instance, the method may include: (1) detecting, via one or more processors, an indication of a sale of a warranty for the item, the indication of the sale including: (i) an indicator of an owner of the item, (ii) an identifier of the item, and/or (iii) an indicator of warranty information associated with a warranty for the item; (2) minting, via the one or more processors, a warranty NFT, wherein the warranty NFT: (a) is owned by the owner of the item, (b) identifies the item, and/or (c) identifies the warranty information of the item, wherein: (i) the warranty NFT identifies the item, and identifies the warranty information of the item by referencing a link to a data storage area, and (ii) the data storage area is configured to store the identifier of the item, and the indicator of the warranty information of the item; and/or (3) adding, via the one or more processors, the minted warranty NFT to a digital wallet associated with the owner of the item. The method may include additional, fewer, or alternate actions, including those discussed elsewhere herein.

In some embodiments, the computer-implemented further includes: detecting, via the one or more processors, a transfer request indicating that ownership of the item is to be transferred to a new owner; validating, via the one or more processors, the transfer request; and/or in response to the validation, transferring, via the one or more processors, the warranty NFT to a digital wallet associated with the new owner.

In some embodiments, the validating comprises authenticating the transfer request based upon a digital signature of: (i) a requester of the transfer, and/or (ii) the new owner.

In some embodiments, the sale of the item occurred via a personal electronic device associated with the owner; and/or detecting the indication of the sale comprises: detecting, via a software package associated with a provider of warranty NFTs executing on the personal electronic device, the indication of the sale, wherein the software package is a public application programming interface (API), a browser plugin or extension, or a standalone application that executes when the personal electronic device is utilized purchase the item.

In some embodiments, the sale of the item occurred via a point-of-sale device at a retail location of a vender of the item; and/or detecting the indication of the sale comprises: detecting, from a computing system associated with the vender, an indication of a purchase of the item, the indication of the purchase including an identifier of the owner; based upon the identifier, identifying contact information associated with the owner of the item; and/or based upon the contact information, transmitting a warranty offer for the item to the owner of the item.

In some embodiments, the identifier of the item includes serial number information, a universal product code (UPC), batch and/or lot information, bar code information, and/or quick response (QR) code information.

In some embodiments, the detecting the indication of the sale of the warranty for the item includes: receiving, from a personal electronic device associated with the owner, information decoded from a bar code and/or quick response (QR) code presented by a point of sale device.

In some embodiments, minting of the warranty NFT includes: transmitting, to the personal electronic device and/or the point of sale device, an offer to the owner to purchase a warranty for the item; detecting, via the one or more processors, acceptance of the offer; and/or minting of the warranty NFT in response to acceptance of the offer.

In some embodiments, the computer-implemented further includes: receiving, via the one or more processors and from a third party, a request to view the warranty information; validating, via the one or more processors, the request; and/or in response to validating the request, providing, via the one or more processors, the warranty information to the third party.

In some embodiments, validating the request comprises: validating, via the one or more processors, that the owner provided an access right that enables the third party to view the warranty information.

In some embodiments, the computer-implemented further includes: deploying, to a distributed ledger associated with the minted warranty NFT, a smart contract configured to (i) detect a temporal condition related to an expiration of the warranty, and (ii) self-execute to solicit one or more extended warranty offers for the item.

In some embodiments, configuring the smart contract to self-execute to solicit the one or more extended warranty offers comprises: configuring, via the one or more processors, the smart contract to self-execute to: generate an access credential for use by a solicited party when requesting the warranty information; and/or generate an extended warranty solicitation request that is (i) addressed to the solicited party and (ii) includes the access credential.

In some embodiments, generating the extended warranty solicitation request to include the access credential comprises: encrypting the access credential using a public encryption key associated with the solicited party.

In another aspect, a computer system for providing a warranty of an item may be provided. The computer system may include one or more local or remote processors, transceivers, sensors, servers, memory units, smart devices, smart vehicles, mobile devices, wearables, smart watches, smart glasses, augmented reality glasses, virtual reality headsets, and/or other electronic or electrical components which are in wired or wireless communication over one or more radio frequency links. For instance, the computer system may include one or more processors configured to: (1) detect an indication of a sale of a warranty for the item, the indication of the sale including: (i) an indicator of an owner of the item, (ii) an identifier of the item, and (iii) an indicator of warranty information associated with a warranty for the item; (2) mint a warranty NFT, wherein the warranty NFT: (a) is owned by the owner of the item, (b) identifies the item, and/or (c) identifies the warranty information of the item, wherein: (i) the warranty NFT identifies the item, and/or identifies the warranty information of the item by referencing a link to a data storage area, and/or (ii) the data storage area is configured to store the identifier of the item, and the indicator of the warranty information of the item; and/or add the minted warranty NFT to a digital wallet associated with the owner of the item. The computer system may include additional, less, or alternate functionality, including that discussed elsewhere herein.

In some embodiments, the one or more processors are further configured to: detect a transfer request indicating that ownership of the item is to be transferred to a new owner; validate the transfer request; and/or in response to the validation, transfer the warranty NFT to a digital wallet associated with the new owner.

In some embodiments, the identifier of the item includes serial number information, a universal product code (UPC), batch and/or lot information, bar code information, and/or quick response (QR) code information.

In some embodiments, the indication of the sale is produced by a personal electronic device associated with the owner in response to a detection of a bar code, and/or a quick response (QR) code.

In yet another aspect, a computing device for providing a warranty of an item may be provided. The computing device may include one or more processors and/or transceivers, and/or one or more memories. The one or more memories having stored thereon computer-executable instructions that, when executed by the one or more processors, may cause the computing device to: (1) detect an indication of a sale of a warranty for the item, the indication of the sale including: (i) an indicator of an owner of the item, (ii) an identifier of the item, and (iii) an indicator of warranty information associated with a warranty for the item; (2) mint a warranty NFT, wherein the warranty NFT: (a) is owned by the owner of the item, (b) identifies the item, and/or (c) identifies the warranty information of the item, wherein: (i) the warranty NFT identifies the item, and/or identifies the warranty information of the item by referencing a link to a data storage area, and/or (ii) the data storage area is configured to store the identifier of the item, and the indicator of the warranty information of the item; and/or add the minted warranty NFT to a digital wallet associated with the owner of the item. The computing device may include additional, less, or alternate functionality, including that discussed elsewhere herein.

In some embodiments, the one or more memories having stored thereon computer executable instructions that, when executed by the one or more processors, cause the computing device to: detect a transfer request indicating that ownership of the item is to be transferred to a new owner; validate the transfer request; and/or in response to the validation, transfer the warranty NFT to a digital wallet associated with the new owner.

In some embodiments, the identifier of the item includes serial number information, a universal product code (UPC), batch and/or lot information, bar code information, and/or quick response (QR) code information.

In some embodiments, the indication of the sale is produced by a personal electronic device associated with the owner in response to a detection of a bar code, and/or a quick response (QR) code.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for providing a warranty of an item, comprising:
detecting, via one or more processors, an indication of a sale of a warranty for the item, the indication of the sale including: (i) an indicator of an owner of the item, (ii) an identifier of the item, and (iii) an indicator of warranty information associated with a warranty for the item;
minting, via the one or more processors, a warranty NFT, wherein the warranty NFT: (a) is owned by the owner of the item, (b) identifies the item, and (c) identifies the warranty information of the item, wherein: (i) the warranty NFT identifies the item, and identifies the warranty information of the item by referencing a link to a data storage area, and (ii) the data storage area is configured to store the identifier of the item, and the indicator of the warranty information of the item; and
adding, via the one or more processors, the minted warranty NFT to a digital wallet associated with the owner of the item.

2. The computer-implemented method of claim 1, further comprising:
detecting, via the one or more processors, a transfer request indicating that ownership of the item is to be transferred to a new owner;
validating, via the one or more processors, the transfer request; and
in response to the validation, transferring, via the one or more processors, the warranty NFT to a digital wallet associated with the new owner.

3. The computer-implemented method of claim 2, wherein the validating comprises authenticating the transfer request based upon a digital signature of: (i) a requester of the transfer, and/or (ii) the new owner.

4. The computer-implemented method of claim 1, wherein:
the sale of the item occurred via a personal electronic device associated with the owner; and
detecting the indication of the sale comprises:
detecting, via a software package associated with a provider of warranty NFTs executing on the personal electronic device, the indication of the sale, wherein the software package is a public application programming interface (API), a browser plugin or extension, or a standalone application that executes when the personal electronic device is utilized purchase the item.

5. The computer-implemented method of claim 1, wherein:
the sale of the item occurred via a point-of-sale device at a retail location of a vender of the item; and
detecting the indication of the sale comprises:
detecting, from a computing system associated with the vender, an indication of a purchase of the item, the indication of the purchase including an identifier of the owner;
based upon the identifier, identifying contact information associated with the owner of the item; and
based upon the contact information, transmitting a warranty offer for the item to the owner of the item.

6. The computer-implemented method of claim 1, wherein the identifier of the item includes serial number information, a universal product code (UPC), batch and/or lot information, bar code information, and/or quick response (QR) code information.

7. The computer-implemented method of claim 1, wherein the detecting the indication of the sale of the warranty for the item comprises:
receiving, from a personal electronic device associated with the owner, information decoded from a bar code and/or quick response (QR) code presented by a point of sale device.

8. The computer-implemented method of claim 7, wherein minting of the warranty NFT comprises:
transmitting, to the personal electronic device and/or the point of sale device, an offer to the owner to purchase a warranty for the item;
detecting, via the one or more processors, acceptance of the offer; and
minting of the warranty NFT in response to acceptance of the offer.

9. The computer-implemented method of claim 1, further comprising:
receiving, via the one or more processors and from a third party, a request to view the warranty information;
validating, via the one or more processors, the request; and
in response to validating the request, providing, via the one or more processors, the warranty information to the third party.

10. The computer-implemented method of claim 8, wherein validating the request comprises:
validating, via the one or more processors, that the owner provided an access right that enables the third party to view the warranty information.

11. The computer-implemented method of claim 1, further comprising:
deploying, to a distributed ledger associated with the minted warranty NFT, a smart contract configured to (i) detect a temporal condition related to an expiration of the warranty, and (ii) self-execute to solicit one or more extended warranty offers for the item.

12. The computer-implemented method of claim 10, wherein configuring the smart contract to self-execute to solicit the one or more extended warranty offers comprises:
configuring, via the one or more processors, the smart contract to self-execute to:
generate an access credential for use by a solicited party when requesting the warranty information; and
generate an extended warranty solicitation request that is (i) addressed to the solicited party and (ii) includes the access credential.

13. The computer-implemented method of claim 11, wherein generating the extended warranty solicitation request to include the access credential comprises:
encrypting the access credential using a public encryption key associated with the solicited party.

14. A computer system for providing a warranty of an item, the computer system comprising one or more processors configured to:
detect an indication of a sale of a warranty for the item, the indication of the sale including: (i) an indicator of an owner of the item, (ii) an identifier of the item, and (iii) an indicator of warranty information associated with a warranty for the item;
mint a warranty NFT, wherein the warranty NFT: (a) is owned by the owner of the item, (b) identifies the item, and (c) identifies the warranty information of the item, wherein: (i) the warranty NFT identifies the item, and identifies the warranty information of the item by referencing a link to a data storage area, and (ii) the data storage area is configured to store the identifier of the item, and the indicator of the warranty information of the item; and
add the minted warranty NFT to a digital wallet associated with the owner of the item.

15. The computer system of claim 14, wherein the identifier of the item includes serial number information, a universal product code (UPC), batch and/or lot information, bar code information, and/or quick response (QR) code information.

16. The computer system of claim 14, wherein the indication of the sale is produced by a personal electronic device associated with the owner in response to a detection of a bar code, and/or a quick response (QR) code.

17. A computing device for providing a warranty of an item, the computing device comprising:
one or more processors; and
one or more memories;
the one or more memories having stored thereon computer-executable instructions that, when executed by the one or more processors, cause the computing device to:
detect an indication of a sale of a warranty for the item, the indication of the sale including: (i) an indicator of an owner of the item, (ii) an identifier of the item, and (iii) an indicator of warranty information associated with a warranty for the item;
mint a warranty NFT, wherein the warranty NFT: (a) is owned by the owner of the item, (b) identifies the item, and (c) identifies the warranty information of the item, wherein: (i) the warranty NFT identifies the item, and identifies the warranty information of the item by referencing a link to a data storage area, and (ii) the data storage area is configured to store the identifier of the item, and the indicator of the warranty information of the item; and
add the minted warranty NFT to a digital wallet associated with the owner of the item.

18. The computing device of claim 17, wherein the one or more memories having stored thereon computer executable instructions that, when executed by the one or more processors, cause the computing device to:
detect a transfer request indicating that ownership of the item is to be transferred to a new owner;
validate the transfer request; and
in response to the validation, transfer the warranty NFT to a digital wallet associated with the new owner.

19. The computing device of claim 17, wherein the identifier of the item includes serial number information, a universal product code (UPC), batch and/or lot information, bar code information, and/or quick response (QR) code information.

20. The computing device of claim 17, wherein the indication of the sale is produced by a personal electronic device associated with the owner in response to a detection of a bar code, and/or a quick response (QR) code.
